(19) United States
(12) Patent Application Publication
(10) Pub. No.: US 2026/0193509 A1
(43) Pub. Date: Jul. 9, 2026

(54) POLYMER BASED COMPOSITE MATERIALS WITH INCREASED THERMAL CONDUCTIVITY

(71) Applicants: Sabanci Üniversitesi, Tuzla/Istanbul (TR); EUROTEC MUHENDISLIK PLASTIKLERI SANAYI VE TICARET ANONIM SIRKETI, Tekirdag (TR)

(72) Inventors: Burcu SANER OKAN, Tuzla/Istanbul (TR); Mehmet YILDIZ, Tuzla/Istanbul (TR); Murat CANSEVER, Tekirdag (TR); Selin ARICAN, Tekirdag (TR)

(21) Appl. No.: 19/133,206

(22) PCT Filed: Nov. 14, 2023
(86) PCT No.: PCT/TR2023/051327

§ 371 Date: May 27, 2025

(30) Foreign Application Priority Data
Nov. 28, 2022 (TR) 2022/018041

(51) Int. Cl. C09K 5/14; B29B 9/06; B29B 9/12; B29C 48/00; B29C 48/05; B29C 48/355; B29K 71/00; B29K 309/04; C08J 3/20; C08K 3/013; C08K 3/38; C08L 71/00; C08L 79/08

(52) U.S. Cl. CPC C09K 5/14; B29B 9/06; B29B 9/12; B29C 48/0022; B29C 48/022; B29C 48/05; B29C 48/355; C08J 3/201; C08K 3/013; C08K 3/38; C08L 71/00; C08L 79/08; B29C 2793/0027; B29C 2793/009; B29K 2071/00; B29K 2309/04; B29K 2995/0013; C08J 2371/10; C08J 2379/08; C08J 2481/06; C08K 2003/385; C08K 2201/001; C08K 2201/005; C08K 2201/011

(57) ABSTRACT

The present invention relates to polymer-based composite materials containing a polyether ether ketone-containing polymer matrix, and hexagonal boron nitride particles dispersed in the polymer matrix as a reinforcement component, and to a method for obtaining same.

### TECHNICAL FIELD OF THE INVENTION

The present invention relates to polymer-based composite materials reinforced with boron nitride-containing reinforcement materials, and the production methods thereof.

### BACKGROUND OF THE INVENTION

Polymer composites are formed by incorporating one or more different types of components into polymer-based materials and combining the mixture at the macro level. A polymer composite mainly comprises a polymer matrix and reinforcement and/or filler components contained in the matrix. Such components are generally responsible for increasing the mechanical strength of the polymer and/or giving it a new functional property.

Reinforcement and filling materials may be granular or fibrous. As granular reinforcement materials, organic and/or inorganic components are used, having different shapes and geometries, such as flakes, pellets, granules, etc. The issue that which component is to be used as a reinforcement material, and in which form and geometry, is one of the criteria that determine the mechanical properties of the final composite material. In this regard, reinforcement materials are selected taking into account the mechanical and functional properties desired in the composite material. In case more than one function is desired in the composite polymer, the selected reinforcement materials should be selected such that they do not eliminate each other's effects and, if possible, operate in coordination.

One of the points to be considered in the production of polymer composites is the homogeneous distribution of the reinforcement material in the matrix. Otherwise, local aggregation areas are generated in the matrix, which causes an uneven distribution of the functionality in the final product. For example, in the development of composite materials with increased thermal conductivity, local hot spots and thermal fatigue may occur in the final product due to non-homogeneous mixing of the reinforcement material. In this regard, the variability of the mechanical and thermal behavior of the material is of critical importance in terms of the quality and lifespan of the product, as it directly affects the thermal conductivity rate of the final product.

In the prior art, there are also studies on PEI and PEEK composites. In particular, in case of polyether ether ketone (PEEK) materials, they are known to exhibit low thermal conductivity, although they provide exceptional performance in terms of high temperature resistance, low density, flexibility, insulating capability, chemical resistance, and dimensional stability. Although PEEK materials, which show high performance in many aspects, are often preferred as a polymer matrix in polymer composites, there are ongoing studies in the art for increasing their thermal conductivity with metallic or carbon-based additives. However, while these composite materials provide increased thermal conductivity, they, on the other hand, compromise on their electrical insulation properties due to the chemical structures of the reinforcement materials contained therein.

In addition, there are studies in the art recommending the use of hexagonal boron nitride (h-BN) as a reinforcement material. However, since the methods proposed in these studies do not allow the addition of high amounts of h-BN, it is not possible to achieve the desired conductivity values by using h-BN alone. On the other hand, the addition of h-BN reinforcement at high amounts deteriorates the homogeneity and reduces the quality of the final product. It is also sought to solve these problems with the combined use of h-BN and metal or carbon-based materials.

For example, WO2020225678A1 describes the preparation of a polyether ether ketone-based composite polymer. Accordingly, it is disclosed that said composite material contains 60-80% PEEK, 5-10% PTFE, 10-20% boron nitride, and 5-10% carbon fiber. It is also stated that boron nitride particles have a hexagonal structure. The extrusion granulation for the production of the composite materials of the invention is carried out in a multi-stage, twin-screw extruder at temperatures of 360-390° C. and mixing speeds of 150-200 rpm. In the said extruder, boron nitride is introduced through a main feeding channel, while the carbon fiber is supplemented through a lateral feeding channel.

On the other hand, although different techniques are proposed in the art for the production of polymer composite materials that provide increased thermal conductivity in in-plane direction and/or in through-plane direction, it is insufficient to increase through-plane thermal conductivity homogeneously while preserving electrical insulation, especially in PEEK-based composite materials.

In summary, considering the current state of the art, it is apparent that said improvements are not able to provide sufficient and/or homogeneous thermal conductivity in PEEK-based composite materials. In this regard, it is considered that there are still needs for PEEK-based composite materials, which have both in-plane and through-plane increased thermal conductivity, exhibit homogeneous thermal conductivity at every point of the material, and also provide electrical insulation, as well as PEEK-based composite films obtainable therefrom, and production methods thereof.

### OBJECTS OF THE INVENTION

A main object of the present invention is to eliminate the above-mentioned shortcomings and disadvantages of the prior art.

Another object of the present invention is to obtain polymer-based, especially PEEK-based, composite materials with in-plane and through-plane increased thermal conductivity.

Another object of the present invention is to obtain PEEK-based composite materials that do not contain metallic or carbon-based reinforcement, thus providing electrical insulation.

Another object of the present invention is to obtain PEEK-based composite materials that can be used instead of metal materials, thanks to their high thermal performance.

Another object of the present invention is to obtain PEEK-based composite materials that provide lightness, freedom in the design of the parts, and ease of production, in the products in which they are used.

Another object of the present invention is to obtain PEEK-based composite materials providing cost advantages when substituted with metal materials.

Another object of the present invention is to obtain PEEK-based composite materials, allowing to obtain maintenance-free products, thanks to their high corrosion resistance, when substituted with metal materials.

Another object of the present invention is to obtain fireproof PEEK-based composite materials.

Another object of the present invention is to obtain PEEK-based composite materials with increased processability and dimensional stability.

Another object of the present invention is to obtain colorable PEEK-based composite materials.

Another object of the present invention is to obtain PEEK-based composite materials with expanded usage areas.

Another object of the present invention is to provide a production method to obtain polymer-based composite materials as defined above, which allows loading high amounts of filling and/or reinforcement materials into the polymer matrix while allowing them to be distributed homogeneously within the matrix.

Another object of the present invention is to provide a production method in order to obtain polymer-based composite materials as defined above, wherein raw material and production costs are reduced.

Another object of the present invention is to provide a production method in order to obtain polymer-based composite materials as defined above in the form of uniformly sized granules, wherein the shear forces in the extruder are reduced and thus the process is facilitated.

Another object of the present invention is to obtain composite films and composite filaments containing composite materials obtained by a method as defined above.

Still another object of the present invention is to obtain PEEK-based composite films that displaying increased and homogeneous in-plane and through-plane thermal conductivity.

### BRIEF DESCRIPTION OF THE INVENTION

The present invention provides polymer-based composite materials containing a polyether ether ketone (PEEK)-containing matrix, and hexagonal boron nitride particles (h-BN) dispersed in the polymer matrix as a reinforcement component. Thus, a PEEK-based composite material with increased functionality is obtained by combining the high temperature resistance, low density, flexibility, insulating capability, chemical resistance and dimensional stability of the PEEK material with the high thermal conductivity of the h-BN particles. In addition, since both PEEK and h-BN particles have electrical insulating properties, the final composite material not only exhibits high thermal conductivity but also can be used as an electrical insulator. The PEEK material which is specifically selected as the polymer matrix and the h-BN particles which are specifically selected as the reinforcement material show a synergistic effect, making it possible to obtain a final composite material with a thermal conductivity much higher than expected.

According to an embodiment, the ratio of hexagonal boron nitride particles in the total composite material is in the range of 5-70% by weight. According to a more preferred embodiment, this rate is in the range of 30-60%.

According to an embodiment, the average particle size (d₅₀) of hexagonal boron nitride particles is in the range of 50 nanometers to 50 micrometers. According to the most preferred embodiment, this value is in the range of 1 micrometer to 30 micrometers. It is observed that when hexagonal boron nitride is used with average particle sizes in these ranges, it is mixed more homogeneously with PEEK and the synergistic effect is increased.

According to an embodiment, the polymer-based composite material comprises at least one secondary reinforcement component selected from titanium dioxide, aluminum silicate, zinc oxide and barium sulfate components. The secondary reinforcement material provides the composite material with additional functional properties such as colorability, fluidity and radiopacity, it also supports electrical insulation.

According to an embodiment, the proportion of the said at least one secondary reinforcement component in the total composite material is in the range of 5-30% by weight. It is observed that at least one secondary reinforcement component used in this range of ratio has a positive effect on obtaining a homogeneous composite material by facilitating the flow of the composite material in the extruder.

According to an embodiment, the polymer matrix comprises at least one amorphous polymer in addition to PEEK. It is observed that the use of amorphous polymer ensures that the composite material is exposed to less shear force during extrusion, thus improving the processability of the composite material and therefore the dimensional stability of the final product.

According to an embodiment, said at least one amorphous polymer is selected from polyetherimide and polyphenylsulfone. Since the said polymers are cheaper than the PEEK polymer, the use of these amorphous polymers both improves the mechanical properties of the composite material and reduces the production cost. Moreover, since these polymers are fireproof just like PEEK, it is possible to use the final product as a flame retardant in a wide range of applications.

According to an embodiment, the ratio of the at least one amorphous polymer to the polyether ether ketone in the polymer matrix is in the range of 1:1 to 1:20, more preferably in the range of 1:1 to 1:10 by weight. It is observed that these ratio ranges further increase the processability of the composite material.

According to an embodiment, the polymer matrix contains polyetherimide and polyether ether ketone in a ratio of 1:1 by weight.

According to another embodiment, the polymer matrix contains polyphenylsulfone and polyether ether ketone in a ratio of 1:10 by weight.

The invention also comprises a method for the production of the polymer-based composite material of the invention. Accordingly, said method comprises an extrusion step in which a twin-screw extruder is used. By using a twin-screw extruder, it is possible to incorporate a high amount of reinforcement component into the polymer matrix.

According to an embodiment, the extrusion step is carried out in the temperature range of 400-450° C. h-BN particles used as thermal conductive reinforcement material result in a faster cooling of the polymer material during extrusion, and due to the inherent lubricating effect of the additive, it negatively affects the fluidity and processability of the material, when added at high rates. Said temperature range is selected by taking into account the melting point of the polymer matrix, in order to eliminate the heat loss suffered herein and balance the melt flow index of the composite material.

According to an embodiment, the diameter of the extruder used in the extrusion step is 26 mm, with the length/diameter ratio (L/D) being 40.

According to an embodiment, said extruder comprises
at least one main feeding point ensuring that the polymer material forming the polymer matrix is fed into the extruder,
at least one extruder head from which the polymer-based composite material is output from the extruder,
at least two lateral feeding points allowing the reinforcement and/or secondary reinforcement components to be introduced into the polymer matrix.

With the extruder configuration that can be fed from at least three different points, high amounts of reinforcement components can be added while the homogeneity of the composite material can be maintained.

According to an embodiment, the temperature of the extruder head is in the range of 430-450° C. In this way, sudden cooling of the composite strands coming out of the extruder is prevented, thereby avoiding problems such as freezing, breaking and clogging.

According to an embodiment, each screw of the extruder comprises
a plurality of carrier elements interposed between the main feeding point and the extruder head and allowing the polymer material to melt and be conveyed through the extruder,
at least one kneading element that is positioned before and after the carrier elements corresponding to each lateral feeding point, with respect to the flow direction of the material,
at least one feedback element interposed between a kneading element and a carrier element and ensuring that the material is returned to the respective kneading element by reversing the flow direction of the material when unmolten granules are detected in the polymer material.

With the said extruder configuration, the risk of degradation is eliminated and the dispersion of the reinforcing component is increased, so that h-BN particles can be incorporated into the polymer matrix at high rates. This makes it possible to obtain composite materials that exhibit increased and homogeneous thermal conductivity.

According to an embodiment, the extruder also comprises at least two atmospheric degassers, each positioned on a different carrier element. In this way, air bubbles that may remain in the molten material are prevented. Thus, it is prevented that the produced granules have a porous structure, thereby enhancing the mechanical and thermal properties.

According to an embodiment, each said atmospheric degasser is positioned before a lateral feeding point, with respect to the flow direction of the material. This embodiment serves to prevent degradation.

According to an embodiment, the extruder also comprises a vacuum element positioned after the lateral feeding points and kneading elements, with respect to the flow direction of the material. The vacuum element is positioned in close proximity to the extruder exit, allowing the extruded strand, for the last time, to be released from air bubbles that may remain therein.

According to an embodiment, the material forming the polymer matrix is added from at least one main feeding point.

According to this embodiment, hexagonal boron nitride particles are added into the polymer matrix through at least two lateral feeding points. In this way, h-BN can be added into the polymer matrix at high rates and without disturbing the homogeneity.

According to an embodiment, 50-90% by weight of the total hexagonal boron nitride particles are added through a first lateral feeding point with respect to the flow direction of the material, and the remaining hexagonal boron nitride particles are added through a second lateral feeding point. It is observed that homogeneity is achieved at an advanced level with this embodiment.

According to an embodiment, at least one secondary reinforcement component is added through at least one lateral feeding point, along with hexagonal boron nitride particles. In this way, secondary reinforcement components can be added into the polymer matrix while the material is molten.

According to an embodiment, the extrusion step is repeated at least once. It is observed that homogeneity is further increased with this embodiment.

According to an embodiment, said method comprises a transfer step following the extrusion step, in which the strands obtained by the extrusion step are transported.

According to an embodiment, in the said transfer step, the strands coming out of the extruder head are delivered to a granulator such that they do not come into contact with water. In this embodiment, a metal carrier apparatus is preferably used. Thus, sudden fractures resulting from the rapid cooling behavior of composite strands are prevented. In addition, the distance between the extruder and the granulator is also reduced. In this way, it is possible to obtain identical granules during the granulation step of the strands.

According to an embodiment, said method comprises a granulation step following the transfer step, in which granules having equal sizes and properties are obtained from the strands introduced into the granulator.

According to an embodiment, said method comprises a shaping step following the granulation step, in which the final product in the form of a film, powder, mold or filament is obtained from the granules obtained by the granulation step.

According to an embodiment, said shaping step is performed by injection molding.

According to another embodiment, said shaping step is performed by film extrusion.

The invention also provides a composite product obtained by a method for the production of the polymer-based composite material of the invention. Accordingly, said composite product is an electrical insulator and has a thermal conductivity equal to or higher than 2 W/mK. In this way, it provides advantages in terms of efficiency and safety, especially in the aviation industry and electrical and electronic applications in this connection.

### BRIEF DESCRIPTION OF THE DRAWINGS

FIG. 1—is a side view of an extruder used in the production of a polymer-based composite material, according to an embodiment of the invention.

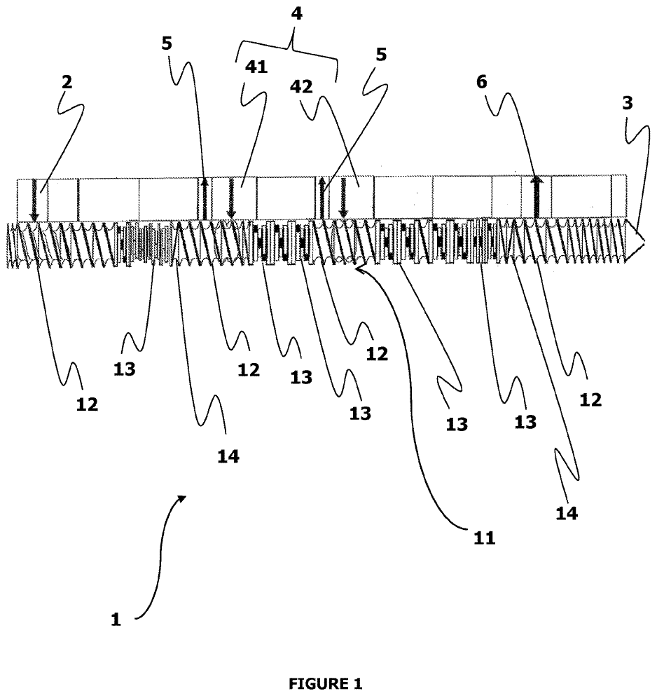

### DETAILED DESCRIPTION OF THE INVENTION

The present invention mainly describes polymer-based composite material containing a polyether ether ketone (PEEK)-containing polymer matrix, and hexagonal boron nitride particles (h-BN) dispersed in the polymer matrix as a reinforcement component.

When the dimensional stability, processability, mechanical strength, electrical stability, chemical resistance and high thermal resistance of the PEEK material are combined with the high thermal conductivity and superior electrical insulation of h-BN particles, the resulting composite material has the structural and functional properties of both materials.

Said hexagonal boron nitride structure is in the form of platelets, also known as flake-like hexagonal particles. H-BN particles are a white, non-toxic, slippery material that is structurally similar to graphite and looks like alumina. It is the material with the lowest density among ceramic materials. Its main difference from graphite is its high electrical resistance.

In an embodiment of the invention, the ratio of hexagonal boron nitride particles in the total composite material is in the range of 5-70%, preferably 30-60% by weight. The average particle size (d₅₀) of these particles is in the range of 50 nanometers to 50 micrometers. According to a preferred embodiment of the invention, the average particle size is in the range from 1 micrometer to 30 micrometers, more preferably from 10 micrometers to 25 micrometers. Said particle sizes are selected by taking into account processes such as granulation and shaping in the process of transforming the composite material into a three-dimensional final product. The average particle sizes of h-BN particles are critical in terms of many aspects, from the uniformity of the granules obtained in the granulation process to the homogeneity of the composite films obtained therefrom.

The composite material of the invention preferably has a hybrid structure containing at least one secondary reinforcement component. Said secondary reinforcement component is selected from suitable materials in order to provide an additional functional property desired in the composite material, or to promote existing properties. In the preferred embodiment of the invention, said at least one secondary reinforcement component is selected from a group comprising titanium dioxide, aluminum silicate, zinc oxide and barium sulfate components.

Said components work in coordination with h-BN, making the thermal conductivity of the composite material of the invention and the products produced therefrom even superior, while also promoting the preservation of electrical insulation. In the aviation industry, especially in electrical and electronic applications, it is required that materials are simultaneously both thermal conductors and electrical insulators. With the insulating nature of the material, the passage of electrical currents is prevented, thus providing an advantage in terms of safety. Within the scope of the invention, the electrical resistance of the composite material is increased by not using carbon-based reinforcement components to achieve thermal conductivity. Another advantage of not using carbon-based reinforcements is that the composite material of the invention can be obtained in natural colors (light tones). h-BN, which is the primary reinforcement component preferred within the scope of the invention, and secondary reinforcement components provide advantages for subsequent colorability of the composite material. Another advantage of these secondary reinforcement components is that they are relatively cheaper than h-BN particles, thus providing a cost advantage while preserving the electrical and thermal properties of the composite material.

In a preferred embodiment of the invention, the at least one secondary reinforcement component contains barium sulfate (BaSO₄). Since barium sulfate is radiopaque, the composite material of the invention is impervious to X-rays in this embodiment of the invention. In this way, it finds a wide range of use in the aviation industry.

In an embodiment of the invention, the ratio of said at least one secondary reinforcement component in the total composite material is in the range of 5-30%, preferably 10-20% by weight.

In a preferred embodiment of the invention, said PEEK-containing polymer matrix also contains at least one amorphous polymer. Said at least one amorphous polymer is selected from polyetherimide (PEI) and polyphenylsulfone (PPSU).

The PEEK polymer is a semi-crystalline high-performance polymer. Amorphous polymers are, on the other hand, known for their high glass transition temperature (Tg). By using PEEK material in blend with amorphous polymer, it is possible to further increase the processability of the composite material. This means that the dimensional stability of the final product is improved in a more effective manner. It is highly important that the materials maintain their dimensions after being molded/shaped. In cases where the dimensional stability of the material is not sufficient, distortions or mold shrinkage problems may occur. The coordinated use of PEEK and amorphous polymers is preferred to prevent these risks. Also, by using amorphous materials, the flow of the material in the extruder is facilitated during the extrusion process and it is exposed to less shear force. Therefore, this embodiment of the invention also increases the processability of the composite material.

PEEK polymer is inherently non-combustible, unlike to the commercial engineering plastics. It is in V0 class when tested according to the UL94 standard. In order to provide fireproof properties to general engineering plastics, it is necessary to add fireproof additive packages. While fireproof additives improve the burning behavior of the material, they negatively affect its mechanical properties. By using PEEK polymer, the need for these additional additive packages is eliminated. Since PEI and PPSU amorphous polymers are inherently non-combustible like PEEK polymer, the usability of the composite materials containing same in the aviation industry is also promoted in this sense.

In addition to the above, since PEI and PPSU polymers are more cost-effective than PEEK polymer, making the polymer matrix in the form of a blend also provides a price advantage.

In an embodiment of the invention, the ratio of at least one amorphous polymer to polyether ether ketone in the polymer matrix is in the range of 1:1 to 1:20, more preferably in the range of 1:1 to 1:10 by weight.

In an embodiment of the invention, the polymer matrix contains polyetherimide (PEI) and polyether ether ketone (PEEK) in a ratio of 1:1 by weight.

In another embodiment of the invention, the polymer matrix contains polyphenylsulfone (PPSU) and polyether ether ketone (PEEK) at a ratio of 1:10 by weight.

The invention also describes a method for production of a composite material according to any of the above embodiments. Accordingly, said method comprises an extrusion step (i) using a twin screw (11) extruder (1).

By using twin screws (11), the dispersion of the reinforcement components incorporated into the polymer matrix is improved, thus making it possible to increase the amount of reinforcement components in the matrix.

In a preferred embodiment of the invention, said extrusion step (i) is performed in the temperature range of 400-450° C. It is observed that this temperature range further increased the dispersion. With this temperature range, not only the melting point of the polymer matrix is taken into account, but also the h-BN particles are prevented from reducing the processability of the polymer material by causing it to cool faster during extrusion.

According to an embodiment of the invention, the diameter of the extruder (1) used in the extrusion step (i) is 26 mm, with the length/diameter ratio (L/D) being 40.

According to the preferred embodiment of the invention, said extruder (1) comprises
at least one main feeding point (2) ensuring that the polymer material forming the polymer matrix is fed into the extruder (1),
at least one extruder head (3) from which the polymer-based composite material is output from the extruder (1),
at least two lateral feeding points (4) interposed between the main feeding point (2) and the extruder head (3), allowing the reinforcement and/or secondary reinforcement components to be introduced into the polymer matrix.

Accordingly, in the most preferred embodiment, the extruder (1) includes a main feeding point (2), an extruder head (3) and two lateral feeding points.

In the preferred embodiment of the invention, the temperature of the said extruder head (3) is in the range of 430-450° C. In this way, problems such as freezing of composite strands, which tend to cool suddenly at the exit of the extruder (1), and/or clogging the extruder head (3), are eliminated. In an embodiment of the invention, the extruder head (3) is also heated by heating resistors.

In the scope of the method of the invention, the entire material forming the polymer matrix (PEEK alone or the blend of PEEK and PEI/PPSU) is preferably added through the main feeding point (2). Accordingly, hexagonal boron nitride particles are added into the polymer matrix through two lateral feeding points (4).

In an embodiment of the invention, 50-90% by weight of the total hexagonal boron nitride particles are added through the first lateral feeding point (41) with respect to the flow direction of the material, and the remaining hexagonal boron nitride particles are added through a second lateral feeding point (42). Thus, the molten material is prevented from being exposed to high shear forces. This allows the addition of higher amounts of reinforcement components with lower energy expenditure. The presence of two separate lateral feeding points (4) is another factor that promotes the addition of high amounts of reinforcement components.

After the polymer material is introduced from the main feeding point (2), it becomes molten until the first lateral feeding point (41). Thus, it is rendered possible to homogeneously incorporate solid primary (h-BN) and secondary reinforcement components into the polymer material. The fact that h-BN has an inherent a sliding effect is another factor that facilitates extrusion.

In a preferred embodiment of the invention, at least one secondary reinforcement component selected from a group comprising titanium dioxide, aluminum silicate, zinc oxide and barium sulfate components is added into the molten material, along with the hexagonal boron nitride particles, through at least one of the lateral feeding points (4). At this stage, different secondary reinforcement components can be fed from different lateral feeding points (4). In the production of hybrid composite materials containing both h-BN and secondary reinforcement components, the fact that the lateral feeding points (4) are divided into two facilitates the homogeneous addition of different reinforcement components into the molten material. Since the h-BN additive has a high volumetric density, it covers more area even though it is light. Given that the volumetric densities of other additives are lower, feeding them into the extruder (1) together with h-BN particles enables higher ratios of reinforcement components.

In an embodiment of the invention, the extrusion step (i) is repeated at least one more time. Accordingly, the strands obtained in the first extrusion step (i) are fed back to the extruder (1) from the main feeding point (2) and passed through the same stages. With this embodiment, if the extrusion step (i) is performed twice instead of feeding the reinforcement components into the highly stable crystalline polymer matrix at once, it is possible to add the primary and secondary reinforcement components at higher rates and obtain more homogeneous strands. Given that the PEEK polymer has a high thermal resistance, it is observed that the applied double extrusion does not negatively affect the structural properties of the material.

In the preferred embodiment of the invention, each screw (11) of the extruder (1) comprises
a plurality of carrier elements (12) interposed between the main feeding point (2) and the extruder head (3) and allowing the polymer material to melt and be conveyed through the extruder (1),
at least one kneading element (13) that is positioned before and after the carrier elements (12) corresponding to each lateral feeding point (4), with respect to the flow direction of the material,
at least one feedback element (14) interposed between a kneading element (13) and a carrier element (12) and ensuring that the material is returned to the respective kneading element (13) by reversing the flow direction of the material when unmolten granules are detected in the polymer material.

In an embodiment of the invention, the carrier elements (12) are positioned on each screw (11) in such a way that they correspond to each other when the screws (11) are disposed in the extruder (1) parallel to each other. In this way, after the addition of the polymer matrix first and then the reinforcement components, the composite material is mixed and conveyed up to the extruder head (3). According to this embodiment of the invention, there are a plurality of kneading elements (13) interposed between the carrier elements (12). There are at least three kneading elements (13) in total in the extruder (1), at least one before each lateral feeding point (4) and at least one after each lateral feeding point (4). In a preferred embodiment of the invention, the extruder (1) comprises at least six kneading elements (13), at least two before and after each lateral feeding point (4). Said kneading elements (13) are positioned on each screw (11) in such a way that they correspond to each other when the screws (11) are disposed in the extruder (1) parallel to each other.

In an embodiment of the invention, each screw (11) comprises two feedback elements (14), one of which is positioned between a kneading element (13) and a carrier element (12), and the other of which is positioned following the last kneading element (13) on the screw (11) with respect to the flow direction of the material. Said feedback elements (14) are positioned on each screw (11) in such a way that they correspond to each other when the screws (11) are disposed in the extruder (1) parallel to each other. It is observed that the homogeneity and stability of the production is increased by using two feedback elements (14).

In a preferred embodiment of the invention, the extruder (1) also comprises at least two atmospheric degassers (5), each positioned on a different carrier element (12). In this way, production of gaseous strands is prevented by preventing air bubbles that may remain in the molten material. Accordingly, each atmospheric degasser (5) is preferably positioned before a lateral feeding point (4), with respect to the flow direction of the material. Thus, reinforcement components can be added into the already degassed polymer matrix or composite material, which promotes homogeneity. According to the most preferred embodiment of the invention, the extruder (1) comprises two atmospheric degassers (5).

In an embodiment of the invention, the extruder (1) also comprises at least one vacuum element (6) positioned after the lateral feeding points (4) and kneading elements (13), with respect to the flow direction of the material. In the most preferred embodiment of the invention, the extruder (1) comprises a vacuum element (6) positioned between the final kneading elements (13) and the extruder head (4), with respect to the flow direction of the material. In this way, it is possible to obtain composite strands that are completely free of gas.

In an embodiment of the invention, the method of the invention also comprises a transfer step (ii), in which the strands obtained by the extrusion step (i) are transported. In the said transfer step (ii), the strands coming out of the extruder (1) are delivered to a granulator so that they do not come into contact with water. Due to their rapid cooling behavior, the strands tend to break or clog the extruder head (3) immediately after leaving the extruder (1), which makes it difficult to obtain identical granules from the said suitable strands. In order to solve this problem, a metal apparatus is used that prevents the strands from coming into contact with water during their transportation to the granulator. The strands are conveyed through the said metal apparatus. In this way, it is possible to obtain identical granules during the granulation step of the strands.

In a preferred embodiment, the strands coming out of the extruder head are at a temperature of 350-400° C., and the temperature of the said metal carrier apparatus is in the range of 23-100° C. While the said distance between the extruder and granulator is around 5 meters in the current state of the art, it is reduced to 2 meters in this embodiment.

In an embodiment of the invention, said method comprises a granulation step (iii) following the transfer step (ii), in which granules having equal sizes and properties are obtained from the strands introduced into the granulator. In this step, it is of great importance in terms of the quality of the final product to obtain equal-sized and homogeneous granules.

In an embodiment of the invention, said method comprises a shaping step (iv) following the granulation step (iii), in which the final product in the form of a film, powder, mold or filament is obtained from the granules obtained by the granulation step (iii). Accordingly, the forming step (iv) can be performed by injection molding or film extrusion or filament extrusion.

It is observed that the thermal conductivity of the final product obtained by granulating (iii) and shaping (iv) of the composite material obtained by a method as defined above, containing PEEK-based polymer matrix and h-BN particles, is surprisingly increased. Specifically, it is observed that the thermal conductivity of the material in granule form, measured after shaping (iv), is equal to or higher than 2 W/mK. The thermal conductivity measurements mentioned herein were carried out using the laser flash method and based on the ISO 22007 standard.

In an embodiment of the invention, the post-injection thermal conductivity of the composite material in granular form, containing PEEK-based polymer matrix and h-BN particles, and obtained by a method as defined above, is equal to or higher than 2 W/mK. Moreover, said composite exhibits electrical insulating properties. On one hand, the products produced from the composite material of the invention provide a cost advantage, and on the other hand, they can be used in a wide range of areas such as electronic devices, aviation applications and medical devices, thanks to their high thermal conductivity and electrical insulation properties.

### LIST OF REFERENCE SIGNS

1. Extruder
2. Main feeding point
3. Extruder head
4. Lateral feeding point
41. First lateral feeding point
42. Second lateral feeding point
5. Atmospheric degasser
6. Vacuum element
11. Screw
12. Carrier element
13. Kneading element
14. Feedback element

1-34. (canceled)

35. A polymer-based composite material containing a polyether ether ketone-containing polymer matrix, and hexagonal boron nitride particles dispersed in the polymer matrix as a reinforcement component, wherein the ratio of hexagonal boron nitride particles in the total composite material is between 30-60% by weight and the polymer matrix also comprises at least one amorphous polymer selected from polyetherimide and polyphenylsulfone such that the ratio of the at least one amorphous polymer to polyether ether ketone in the polymer matrix is in the range of 1:1 to 1:20 by weight.

36. The composite material according to claim 35, wherein the average particle size (d₅₀) of the hexagonal boron nitride particles is in the range of 50 nanometers to 50 micrometers.

37. The composite material according to claim 35, also comprising at least one secondary reinforcement component selected from titanium dioxide, aluminum silicate, zinc oxide, and barium sulfate components.

38. The composite material according to claim 37, wherein the ratio of the at least one secondary reinforcement component in the total composite material is in the range of 5-30% by weight.

39. The composite material according to claim 35, wherein the polymer matrix contains polyetherimide and polyether ether ketone in a ratio of 1:1 by weight.

40. The composite material according to claim 35, wherein the polymer matrix contains polyphenylsulfone and polyether ether ketone in a ratio of 1:10 by weight.

41. A method for the production of a composite material according to claim 35, comprising an extrusion step (i) in which a twin screw (11) extruder (1) is used and which is performed in the temperature range of 400-450° C.

42. The method according to claim 41, wherein the diameter of the extruder (1) used in the said extrusion step (i) is 26 mm, with the length/diameter ratio (L/D) being 40.

43. The method according to claim 41, wherein said extruder (1) comprises:
at least one main feeding point (2) ensuring that the polymer material forming the polymer matrix is fed into the extruder (1),
at least one extruder head (3) from which the polymer-based composite material is output from the extruder (1),
at least two lateral feeding points (4) interposed between the main feeding point (2) and the extruder head (3), allowing the reinforcement and/or secondary reinforcement components to be introduced into the polymer matrix.

44. The method according to claim 43, wherein the temperature of the said extruder head (3) is in the range of 430-450° C.

45. The method according to claim 43, wherein each screw (11) of the extruder (1) comprises:
a plurality of carrier elements (12) interposed between the main feeding point (2) and the extruder head (3) and allowing the polymer material to melt and be conveyed through the extruder (1),
at least one kneading element (13) that is positioned before and after the carrier elements (12) corresponding to each lateral feeding point (4), with respect to the flow direction of the material,
at least one feedback element (14) interposed between a kneading element (13) and a carrier element (12) and ensuring that the material is returned to the respective kneading element (13) by reversing the flow direction of the material when unmolten granules are detected in the polymer material.

46. The method according to claim 45, wherein the extruder (1) also comprises at least two atmospheric degassers (5), each positioned on a different carrier element (12) and each positioned before a lateral feeding point (4), with respect to the flow direction of the material.

47. The method according to claim 46, wherein the extruder (1) also comprises at least one vacuum element (6) positioned after the lateral feeding points (4) and kneading elements (13), with respect to the flow direction of the material.

48. The method according to claim 47, wherein the hexagonal boron nitride particles are added into the polymer matrix through at least two lateral feeding points (4).

49. The method according to claim 48, wherein 50-90% by weight of the total hexagonal boron nitride particles are added through a first lateral feeding point (41) with respect to the flow direction of the material, and the remaining hexagonal boron nitride particles are added through a second lateral feeding point (42).

50. The method according to claim 48, wherein at least one secondary reinforcement component is added through at least one lateral feeding point (4), along with hexagonal boron nitride particles.

51. The method according to claim 41, comprising a transfer step (ii) following the extrusion step (i), in which the strands coming out of the extruder (1) are conveyed on a metal apparatus and delivered to the granulator.

52. The method according to claim 51, comprising a granulation step (iii) following the transfer step (ii), in which granules having equal sizes and properties are obtained from the strands introduced into the granulator.

53. The method according to claim 52, comprising a shaping step (iv) following the granulation step (iii), in which the final product in the form of a film, powder, mold or filament is obtained from the granules obtained by the granulation step (iii).

54. A composite product obtained by a method according to claim 53, wherein it is an electrical insulator and its thermal conductivity is equal to or higher than 2 W/mK.
